(19) United States
(12) Patent Application Publication
(10) Pub. No.: US 2023/0272934 A1
(43) Pub. Date: Aug. 31, 2023

(54) HEATING CONTROL SYSTEM

(71) Applicant: EcoSync Ltd., London (GB)

(72) Inventors: Miklós MOHOS, Obernau (CH); Gábor MAYER, Budapest (HU); Tiago Manuel CAMPELOS FERREIRA PINTO, Salamanca (ES); Zsuzsa Ajsa MAYER, Radley (GB)

(21) Appl. No.: 18/012,346

(22) PCT Filed: Jun. 24, 2020
(86) PCT No.: PCT/EP2020/067764

§ 371 Date: Dec. 22, 2022

(51) Int. Cl. F24F 11/58; F24F 11/64

(52) U.S. Cl. CPC F24F 11/58; F24F 11/64; F24F 2120/12

(57) ABSTRACT

A heating control system is provided for a multi-occupancy building. The heating control system uses a plurality of mobile devices, for example mobile telephones or tablet computers, which connect to a multiple-access-point wireless data network within the building. The wireless access points provide a controller with details of devices connected to each access point, so that occupancy of each heating zone can be estimated. The mobile devices can be used by occupants to send messages to the controller requesting increases or decreases in temperature. In this way, the temperature of heating zones within the building may be regulated taking into account the preferences of all occupants.

The present invention relates to a heating control system, particularly a heating control system for use in multi-occupancy buildings.

### BACKGROUND TO THE INVENTION

Our buildings are responsible for 39% of the global energy consumption and for ⅓ of the CO2 emission.

The energy consumption of the domestic buildings is receiving a lot of attention as their better energy management (e.g. insulating windows, installing smart heating systems etc.) are easy to implement. However, larger institutes managing buildings with hundreds of rooms (hotels, hospitals, higher education institutes, office buildings etc.) are receiving less attention as any energy saving initiative are more difficult to implement.

Difficulties are the higher capital cost requirements but also the complexity of the buildings. While a traditional home with few bedrooms and a family with a regular daily routine can easily choose from smart heating and temperature controlling products already available on the market, a commercial building is dealing with several room types (meeting rooms, offices, shops etc.) with different opening times and schedules therefore a “traditional” temperature control (e.g. a pre-set timer turning the central heating on/off) is not suitable for commercial buildings. In such buildings, unnecessarily heating areas which are not in use (for example empty meeting rooms) is unfortunately quite common.

Another fundamental problem in multi-occupancy buildings, for example offices, is that they need to cater for the different requirements of a large number of different people. At any one time, typically some people will feel too hot and others will feel too cold. Contradictory complaints about the temperature to building managers are common. Building managers will try to adjust settings to please the largest number of people, but this can be difficult to judge. A particular problem for the managers is that they only hear from people who want the temperature to be changed. Those who are happy with the current temperature are typically silent. These factors make it difficult to find the optimal settings for heating control in a multi-occupancy building.

It is an object of the invention to provide a system for better heating control in a multi-occupancy building. We estimate a 30-40% energy saving and carbon reduction opportunity with this invention.

### SUMMARY OF THE INVENTION

According to the present invention, there is provided a heating control system for a multi-occupancy building, the heating control system comprising:
a plurality of temperature sensors for measuring the temperature of heating zones within the building;
means for controlling heating and/or cooling means within the heating zones;
a plurality of wireless data network access points within the building, forming a wireless data network within the building;
a plurality of mobile devices, each mobile device being associated with a building occupant, and each mobile device being connectable to the wireless data network;
a controller connected to the data network,

in which the wireless data network access points are adapted to provide information to the controller as to the mobile devices present within each heating zone, the temperature sensors are adapted to provide information to the controller as to the temperature in each heating zone,

and the mobile devices are provided with a user interface through which a building occupant can send a message to the controller to request that the temperature is increased or decreased,

the controller operating the means for controlling heating and/or cooling means to regulate the temperature in each heating zone based on the number of mobile devices present, the current temperature, the number of messages received from mobile devices requesting that the temperature is increased and the number of messages received from mobile devices requesting that the temperature is decreased.

The temperature sensors and the means for controlling heating and/or cooling means are of types known in the art and already used in “smart home” systems. The means for controlling heating and/or cooling means may include, for example, valves, actuators, switches, relays, etc., depending primarily on the type of heating and/or cooling system being controlled.

The wireless data network is preferably a WiFi network and may be a general-purpose WiFi network, allowing access for example to the Internet as well as internal network resources, specific to the organisation occupying the building. Messages relating to the operation of the system of the invention are likely to form quite a small part of the overall network traffic on the wireless data network. The system preferably operates as a WiFi network with multiple access points, and the ability to roam seamlessly between different access points. The user will usually not be aware of which access point they are currently connected to, but the system is able to track each device and at least approximately locate each device within the building, determining the approximate location based on which access point the device is currently connected to.

The wireless data network access points may provide the controller with specific identifiers of devices connected to them. Alternatively, in some embodiments the access points may simply provide the controller with a count of the number of devices connected. In this latter case, messages from the devices will need to include an indication as to which heating zone the device is in. This could still be done by reference to the access point to which the mobile device is connected.

The mobile devices are preferably mobile telephones or tablet computers, or any other suitable device.

The temperature sensors and/or the means for controlling the heating and/or cooling system may also be connected to the wireless data network. However in other embodiments separate wired or wireless connections may be provided for these components.

It will be appreciated that, although it is important that the data network is wireless in the sense that it includes multiple access points, and the mobile devices connect wirelessly to the network via the access points, parts of the same data network may have wires, for example the wireless access points are likely to be connected together with wires, and the controller and/or the temperature sensors and/or the means for controlling heating and/or cooling means may be connected to the network with wires in some embodiments.

The system preferably at any particular time stores a temperature setpoint for each heating zone, and attempts to regulate the temperature of the heating zone, within parameters, according to the current setpoint. However, the setpoint may be adjusted according to the occupants present in the zone, and their preferences. The messages which can be sent by occupants through their mobile device provide a simple “voting” system whereby occupants can “vote” for the temperature to be increased or decreased. In this way the setpoint can be controlled to try to keep the largest possible number of people relatively happy. The controller knows where the votes are coming from, i.e. which heating zone each device is in, because this information comes from the wireless access points that the devices connect to. Importantly, the controller also knows the total number of mobile devices in each heating zone, including those who are not “voting”. These can be assumed to belong to occupants who are relatively happy with the current temperature. Thus, the wishes of these people can be taken into account when revising the temperature setpoint.

The controller may also take into account other inputs. For example, data from a room booking system. As an example, if a meeting room is booked for an hour from 10 am-11 am, the heating might be switched on at 9:30 am so that the room is warm ready for the meeting. This is done even if at 9:30 am there are no occupants of the meeting. However, if the meeting room is still empty at 10:05 am, then the heating might be switched off again, the assumption being made that the planned meeting was cancelled.

The controller may also use “heating profile” information for particular heating zones. A heating profile for a zone is information about how long it takes the room to heat up after the heating has been switched on, and how long it takes the room to cool down after the heating has been switched off. The controller may “learn” the heating profiles over time, using machine learning techniques. Likewise, the controller may learn “occupancy profiles”, i.e. predict occupancy of rooms based on other inputs. For example, the system might learn that when a meeting room is booked, a nearby break room tends to be used just after the meeting finishes, that when all the meeting rooms are booked the office space tends to have low occupancy, etc.

The controller may also include stored preferences both at the user level (e.g. the user can specify that, wherever they are, they would like it to be 20 degrees), and at the global level (e.g. a facilities manager could specify that, regardless of occupancy, the reception area always needs to be heated during opening hours, that the heating is always turned off at the weekends, and that heating is always turned on if the temperature of a heating zone drops below 5 degrees). The controller includes a database of both current and historical information from the various inputs, and a decision making module for controlling the heating and/or cooling system according to that information.

The messages sent by mobile devices may be explicit in whether they wish the temperature to be increased or decreased, or may be implicit, in that the message from the mobile device might in some embodiments say in substance that “this occupant wants the room to be at 20 degrees”, leaving it to the controller, which has the advantage of information from the temperature sensors in the zone, to determine whether this is a message requesting an increase in temperature or a message requesting a decrease in temperature, or a neutral message.

### DETAILED DESCRIPTION OF EXAMPLE EMBODIMENT

For a better understanding of the invention and to show more clearly how it may be carried into effect, an example embodiment will now be described with reference to drawings.

The Process

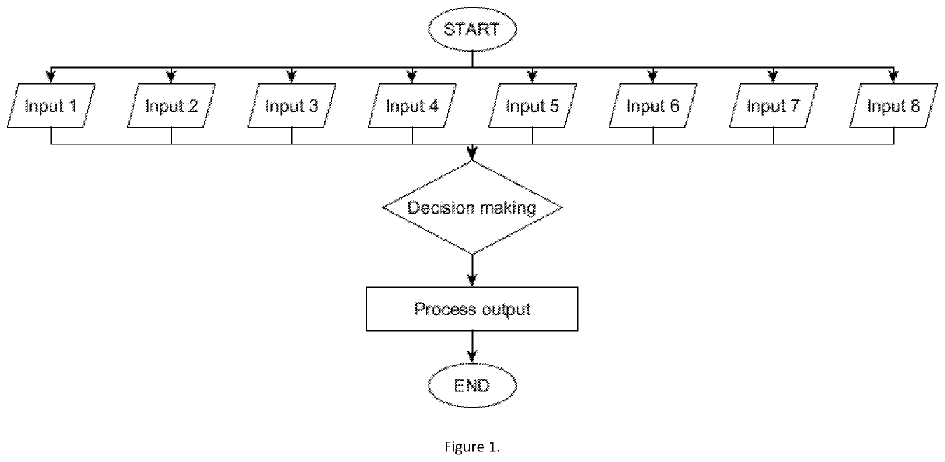

An automatic decision-making process which determines the desirable temperature value in an individual (heating/cooling) zone based on different input parameters (FIG. 1). After decision making, the system sets the status of a zone, triggering a change in temperature setting (output) This output can be used as an input for temperature control (e.g. changing valve status, thermostat settings etc. over time). The system can manage and control large number or even unlimited zones in parallel therefore suitable for commercial buildings like hotels, hospitals, office buildings etc.

See FIG. 1.

Process Elements:

1. Decision Making

1.1. Zone Status and Temperature Settings

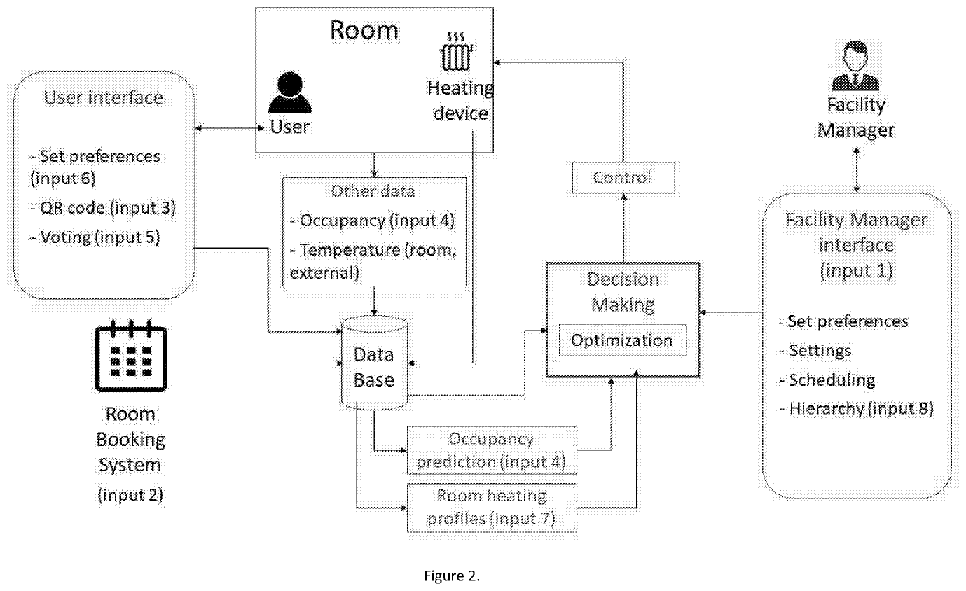

The system's decision-making module can change the status of the room (e.g. in case of a meeting room the status can be changed from ‘booked’ to ‘not booked’), triggering changes in the temperature setting and starting heating/cooling actions. The decision-making model can be applied to any zones using several inputs and preferences that are listed and explained in the following sections (FIG. 2).

See FIG. 2.

In case of the presence of several inputs in the system, the inputs are collected in different categories then the hierarchy of the different input categories can be defined (see Input 8 for detailed description). According to this hierarchy, the system can prioritize between process inputs and uses the most relevant one for decision making. In this way, default and default/custom scheduling (Input 1), data from any room booking systems (Input 2), manual user input via QR codes (Input 3), occupancy detection and prediction (Input 4), voting (Input 5), and the use of stored user preferences (Input 6) can be prioritized and used according to the defined preferences (Input 8).

When there is no active input, the temperature settings of zones return to their default status, defined by Input 1 and Input 8.

Summary: The decision-making step considers all the system inputs to define the heating/cooling actions to be performed at each time in each room.

1.2. Timing (Optimisation Module)

The hierarchy of inputs is used to prioritize between process inputs and to ensure that every zone of the building has the right temperature settings. As each zone's energy demand and response time is different in case of a change in temperature settings, an optimisation algorithm is also used to determine the optimal timing to start increasing, decreasing, turn on and off the heating/cooling devices.

The optimisation algorithm is used to ensure that any zone temperatures are the same as set temperatures e.g. by the time a meeting is about to start. The optimisation algorithm is also used to optimise the energy demand of the zones when changing temperature settings (e.g. making a decision if the energy consumption of a zone is better when the temperature setting goes into default between two meetings or if it stays unchanged.

This optimization step uses information like the heating/cooling profile of the zones (see also Input 7) in order to determine the amount of time needed for a zone to reach the set temperature determined by the decision-making process.

Summary: An optimization process is used to maximize the user comfort (according to users' set temperatures) and minimize the energy costs, using the data from the several inputs and the most updated room heating/cooling profiles.

1.3. Preferences and Predictions Module

The stored user preferences are either used as an individual input (see Input 6) or to cast automatic votes when users' presence is detected (see Input 5).

The decision-making process can also change the status of a zone e.g. when it is expected that a user will be in the room (through occupancy prediction, see Input 4) e.g. from “unoccupied” to “occupied”.

2. Process Inputs

The following points describe the different process inputs of the decision-making algorithm, determining the output (temperature settings) for each individual zones. The minimum requirement for the proper operation of the system is to have at least one Input (e.g. a default parameter defined by Input 1).

All Inputs are optional but increasing the number of Inputs increases the sophistication of temperature control and improves system behaviour with the added value of increased user satisfaction and reduced energy consumption of the buildings.

2.1. Input 1: Facilities Manager Interface

A “Facilities Manager Interface” is a graphical user interface where the responsible person of the building/facility sets up basic settings for the entire “system”. These parameters determine the core and the basic behaviour of the “system” without any further intervention (without further inputs). The basic parameters can be determined before activating the “system” or while the system is running.

The main settings on the “Facilities Manager Interface”:
a. “Zone type”: Determines the type of the individual heating/cooling zones. Facilities manager could choose from different predefined types (ie: shop, meeting room, shared office accommodation, etc.).
There could be single use (ie: private office, accommodation room, etc.) and multi-use (ie: seminar room, meeting room, shared office, communal area, etc.) zones. User of a single use zone could directly modify the temperature setting via the user interface between the certain limits the FM determined (Tmin-Tmax). In case of multi-use zone, the users can vote via the user interface and the voting algorithm determines the best-optimal temperature value based on the different votes (see: input 5 and input 6).
b. “Status”: Each zone can have different statuses. The zone status can change, depending on occupancy and usage. Zones can be out of use e.g. because of renovation (status is ‘long term inactive’), occupied (‘active’) temporarily unoccupied (‘temporarily away’) etc. depending on usage. Zone statuses have predefined parameters (see table x). Zone status can change several times during the day, triggering changes in the temperature settings.
c. T default: Determines the default temperature value for the different room statuses.
d. T min: Determines the minimum temperature value what a user can set.
e. T max: Determines the maximum temperature value what a user can set.
f. Longevity of user votes for zones with multiple users with “voting feature (Input 5) enabled
g. Hierarchy of different system Inputs
Table 1 shows an example for parameters of point a-e:

TABLE 1

| | | T_{default} | Tₘᵢₙ | Tₘₐₓ |
|---|---|---|---|---|
| Zone type | Status | (° C.) | (° C.) | (° C.) |
| accommodation | occupied active | 21 | 15 | 23 |
| | occupied inactive | 16 | — | — |
| | (temporarily away) | | | |
| | occupied night | 19 | 15 | 21 |
| | not in use (long | 10 | — | — |
| | term inactive) | | | |
| shared offices | occupied active | 21 | 18 | 22 |
| | occupied inactive | 19 | 15 | 21 |
| | (temporarily away) | | | |
| | not in use (long | 10 | — | — |
| | term inactive) | | | |
| private office | occupied active | 21 | 18 | 22 |
| | occupied inactive | 19 | 15 | 21 |
| | (temporarily away) | | | |
| | not in use (long | 10 | — | — |
| | term inactive) | | | |
| museum/shop/ | open | 20 | — | — |
| café | close | 16 | — | — |

h. Scheduling: Facilities Manager can allocate a schedule for the different zones with a schedule automatically changing the status of the room following the settings. (E.g. changing from “open” status to “closed” status in case of a zone defined as “museum”.) The different statuses of the zones have predefined temperature settings—see c, d and e).
   i. As part of the graphical interface, Facilities Managers can define the details of a default schedule (ie: “open” status is defined as Monday-Saturday, from 7 am until 10 pm. morning at 10 am, the zone 1 (ie: museum) is OPEN. (See Table 2 as example). The settings of the default schedule can be modified by Facilities Manager.

TABLE 2

| | | Default Schedule | | | | |
|---|---|---|---|---|---|---|
| Zone type | Status | Days | start | | end | |
| accommodation | occupied active | Mo, Tu, We, | 7 | am | 10 | pm |
| | | Th, F, Sa, | | | | |
| | | Su | | | | |
| | occupied inactive | — | — | | — | |
| | (temporarily away) | | | | | |
| | occupied night | Mo, Tu, We, | 10 | pm | 7 | am |
| | | Th, F, Sa, | | | | |
| | | Su | | | | |
| | not in use (long | — | — | | — | |
| | term inactive) | | | | | |
| Hallways | active | Mo, Tu, We, | 7 | am | 8 | pm |
| | | Th, F | | | | |
| | inactive | Mo, Tu, We, | 8 | pm | 7 | am |
| | | Th | | | | |
| | not in use (long | F | 8 | pm | 0 | am |
| | term inactive) | Sa, Su | 0 | am | 12 | pm |
| museum/shop/ | open (1) | Mo, Tu, We, | 9 | am | 5 | pm |
| café | | Th, F | | | | |
| | open (2) | Sa | 9 | am | 3 | pm |

| | |
|---|---|
| close | rest of the time |

ii. Custom/Manual Schedule: Facilities Manager can modify the pre-set default schedule any time for specific dates or zones. Outside of the manually specified dates, the default schedule settings will still apply (ie.: during a holiday period Zone 1 defined as ‘Museum’ can have a different opening time than usual. Changes in zone status will follow the custom schedule on the specific dates then returns to the default schedule after.)

If the system is capable to detect non-desirable events (ie: open window, malfunction of the heat exchanger, etc.), it can automatically send notifications for the corresponsive person(s) (e.g. Facilities Manager) or act automatically to correct the non-desirable event.

2.2. Input 2: Room Booking System

Commercial buildings often use resource booking tools for space management and room booking. These are either cloud based or local software solutions. The software can be commissioned by the institute or purchased like PlanOn, MICAD, Kinetics Solutions etc. from a software provider. Institutes also often use shared calendars like Google Calendar, Microsoft Exchange calendars, Outlook for space management.

Professional space management softwares often use SQL databases with a browser-enabled room booking front-end.

With occupancy information already in the room booking system in use, the room booking data can be used as an input for heating/cooling control (room booking-temperature control).

With a custom-made built in API (API 1), the system pulls data directly from the primary data source of the existing room booking system through an API (API 2). Data can be also pushed instead of pulling, (from API 2 to API 1) according to the preferences of the facilities management.

API 1 uses the protocol specified by API 2 and system's cloud ensures that room availability (occupancy status) is updated in real time.

An API (ie. API 2) can be commissioned from and set up by the software provider. When this is not an option, EcoSync develops a custom made, local API (ie. API 2), after receiving secured access to the data source and documentation.

After developing or installing a API 2, the room booking systems can automatically send all information required to update system's cloud-based database. (AKA push data from API 2 to API 1.)

In those cases when an API solution is not available, the room booking information can be manually exported and imported into the system's database in a number of digital formats (eg. MS Excel Spreadsheets).

### SUMMARY

Using the primary data source of the existing cloud based or local room booking software of the buildings, system has room availability and occupancy information updated in real time, used as an input for decision making.

Example for API for Planon room booking system integration: https://github.com/mhvis/planon

2.3. Input 3: User Interface with QR Code Access

Each zone have individual and unique URLs and corresponding QR codes displayed in the zone, designed for easy access with a mobile device or computer. The web address specified by the QR code/URL leads to a unique page of the user interface. This user interface provides easy access to temperature settings/voting for users without installing any applications but identifies the exact location (zone) of the user.

User(s) can reach the User Interface by typing the URL code into an internet browser, or by scanning a two-dimensional barcode (QR code) with a mobile device.

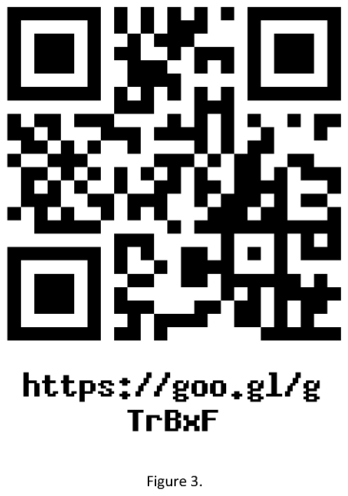

See FIG. 3.

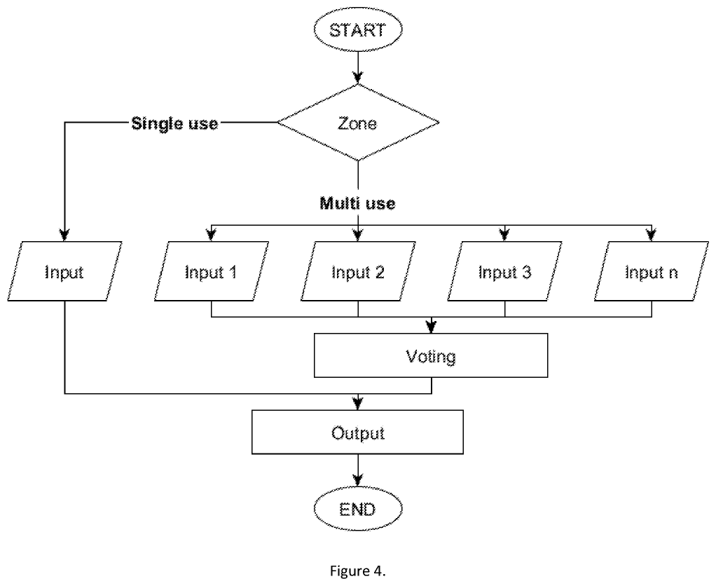

The User Interface can display relevant information (e.g. the zone and current temperature setting or real time temperature) with the option for user to modify it within a temperature defined by Facilities Managers (See also Input 1). Based on the zone type (e.g. shared office or a private office) the user preference is directly translated as an Input (e.g. in case of a private office or accommodation type of zone—see also Input 1, point d-e) or is taken into account as a “vote” (see Input 3). This is relevant in multi-users zones like shared offices, meeting rooms etc. (FIG. 4)

Instead of QR codes other machine-readable optical labels can be also used to provide URL for instant access.

See FIG. 4.

2.4. Input 4: Real-time Occupancy Detection

User occupancy along the building or in individual zones can be determined or estimated in real time through presence detection counters, sensors or the existing Wi-Fi network of the building. (e.g. data from the access points, access point controllers or the dashboard of the Wi-Fi system registering the Wi-Fi enabled devices connected to different access points used to estimate the number of users.

For more accurate location identification (indoor positioning) a triangulation technique can be also used.

The real-time occupancy detection is used for two purposes:
a. Change the status of the room automatically. E.g. if unexpected user presence is detected in a zone previously determined as “unoccupied”, the input can be used to change the room status to “occupied”, so the status and the temperature settings can be adjusted accordingly. The same occupancy detection can be used for security purposes—e.g. a zone defined as ‘Museum’ receiving an input/request suggesting that the zone is occupied while scheduled to be “closed” can trigger a notification about the presence of an unauthorised person.
b. Monitor occupancy patterns for prediction purposes. The historical data on each room's occupancy is combined with the occupancy data acquired in real-time in order to feed a machine learning algorithm that identifies occupancy patterns. Occupancy patterns of the zones can be used to predict occupancy and change the status of the zones.

Real-time or historical data, like Input 2, can be pulled, pushed or manually exported.

Summary: Real-time detection of occupancy in each room is used to manage rooms' heating/cooling management settings and for occupancy patterns prediction purposes.

2.5. Input 5: Voting

Traditional thermostats in case of multiple user access cannot distinguish between inputs and the last temperature setting automatically overwrites the settings of the previous users, creating tensions between co-workers sharing offices and other zones.

Multi-user zones (e.g. shared offices, meeting rooms etc.) can receive several temperature change requests via the User Interface. To select the ideal output (temperature setting) for a zone occupied by multiple users, the voting algorithm uses a parameterized background algorithm inside the system. The algorithm uses individual user temperature preferences to determine the most suitable set temperature for the zone (ie. vote received via the User Interface point 3). Votes can be averaged, weighted, normalised by the total number of people in the zone (see Input 4) etc.

The parameters of the algorithm are the following:
a. Operating times of zones, scheduling (point 1.i.)
b. Default, Minimum, Maximum available temperatures (set in point 1.b-d.)
c. Individual user temperature preferences (votes) received via the User Interface
d. Longevity of votes, the length of time a vote has effect from the time of casting it.
e. Mathematical function (aka. graph) that has the number of users present (eg. x axis of the graph) in the zone (occupancy detection —see Input 4 point 4) and the amount of active voters (eg. y axis of the graph) as input and on it's output (eg. z axis) the new temperature setting that the voting will cause. eg. a possible function: fn(x,y)=T min+(T max−T min)*(O_{active}/Oₚᵣₑₛₑₙₜ)

2.6. Input 6: Remembering User Temperature Preferences

The personal temperature setting preference of a user (for specific zones or in general) can be stored in the system. When a user arrives to a zone the system recognises their presence and casts a vote in behalf of them automatically according to their previously set preferences.

In case if the local regulations are not allowing to store any user data in the system because of personal-individual rights, then it is possible that the system only links the identifier number of the device itself (ie: IP or MAC address), which the user used to change her/his preference, with the preferred temperature setting.

2.7. Input 7: Adaptive Room Heating/Cooling

Historical data on zones e.g. actual temperature of the zone, external temperature, heating control (valve statuses) etc are analysed by a machine learning algorithm, which identifies the time needed to reach a target temperature from the current temperature in each room, considering each current situation. The algorithm is used to create a unique and adaptive heating/cooling profile for each zone; The room heating/cooling profile can be continuously updated by being fed by the real-time acquired data (sensor data, inputs, third party information etc). In this way, the heating/cooling profiles of the zones are adaptive to changes in the environment (e.g. change of room conditions, such as a window being open or closed; the installation of a new, more energy efficient window; or the change in users' habits by leaving the doors between different rooms open or closed more often—causing a significant impact in the heating/cooling profile of the zone.)

Information gained from the heating/cooling profile of zones can be used as Input 7 and fine-tune the direct temperature setting requests coming from Input 1-6.

Summary: The adaptive room heating/cooling algorithm identifies the time needed to reach a target temperature in each zone.

2.8. Input 8: Hierarchy

With several optional Inputs, the system needs to determine which input to take into account when more options are available.

For example a private office could be set up by the “Facilities Manager” as a zone active (in use) on weekdays from 9 am to 5 pm while the actual user of the office might have differences—e.g. working from 8 am to 4 pm on certain days and away other days. This means contradicting status for the zone from the Default Schedule of the Facilities Manager, User Interface, Occupancy Detection, Prediction etc.

A pre-set hierarchy of the available and enabled Inputs can be pre-defined by Facilities Manager via the graphic user interface and modified later (See also Input 1g)

The hierarchy defines which inputs are active for a specific zone and what is their order in case of several inputs. The input set higher in the hierarchy will define the status of the zone therefore its temperature settings.

The invention provides a heating control system for a multi-occupancy building. The heating control system uses a plurality of mobile devices, for example mobile telephones or tablet computers, which connect to a multiple-access-point wireless data network within the building. The wireless access points provide a controller with details of devices connected to each access point, so that occupancy of each heating zone can be estimated. The mobile devices can be used by occupants to send messages to the controller requesting increases or decreases in temperature.

In this way, the temperature of heating zones within the building may be regulated taking into account the preferences of all occupants.

The description of this embodiment is given as an example only. Variations and modifications will be apparent to the skilled person, within the scope of the invention. The invention is defined in the claims.

1. A temperature control system for a multi-occupancy building, the temperature control system comprising:
a plurality of temperature sensors for measuring the temperature of heating/cooling zones within the building;
means for controlling heating and/or cooling means within the heating/cooling zones;
a plurality of wireless data network access points within the building, forming a wireless data network within the building;
at least one mobile device, being associated with a building occupant, and each mobile device being connectable to the wireless data network;
a controller connected to the data network,
in which the wireless data network access points are adapted to provide information to the controller as to the mobile devices present within each heating/cooling, zone,
the temperature sensors are adapted to provide information to the controller as to the temperature in each heating/cooling zone,
and each of the at least one mobile device is adapted to be provided with a user interface through which a building occupant can provide a temperature preference to the controller,
the controller operating the means for controlling heating and/or cooling means to regulate the temperature in each heating/cooling zone based on the current temperature and; the temperature preference received from each mobile device of the at least one mobile device,
wherein a machine-readable token is provided in each heating/cooling zone, wherein the machine-readable token specifies a website address that leads to a unique page of the user interface, and wherein the user interface identifies the heating/cooling zone of the machine-readable token.

2. A temperature control system as claimed in claim 1, in which the wireless data network access points are adapted to provide identifiers associated with connected mobile devices to the controller.

3. A temperature control system as claimed in claim 1, in which the wireless data network access points are adapted to provide a count of the number of connected mobile devices to the controller.

4. A temperature control system as claimed in claim 1, in which the temperature sensors are connected to the data network.

5. A temperature control system as claimed in claim 1, in which the means for controlling the heating and/or cooling means are connected to the data network.

6. A temperature control system as claimed in claim 1, in which the controller operates the means for controlling the heating and/or cooling means to regulate the temperature in each heating/cooling, according to a temperature setpoint associated with each heating/cooling, the temperature setpoint for a particular zone at a particular time being determined based on at least the number of mobile devices present in the zone, the number of messages received from mobile devices in the zone requesting that the temperature is increased and the number of messages received from mobile devices in the zone requesting that the temperature is decreased.

7. A temperature control system as claimed in claim 6, in which the controller regulates the temperature in each heating/cooling zone further based on information from an electronic room booking database or electronic calendar.

8. A temperature control system as claimed in claim 7, in which the setpoint is determined further based on information from an electronic room booking database or electronic calendar.

9. A temperature control system as claimed in claim 1, in which the controller regulates the temperature in each heating/cooling zone further based on a heating/cooling profile for the heating/cooling zone.

10. A temperature control system as claimed in claim 9, in which the controller is adapted to update the heating/cooling profile using measurements from the temperature sensors, according to a machine learning algorithm.

11. (canceled)

12. A temperature control system as claimed in claim 1, in which the machine-readable token is a

13. A temperature control system as claimed in claim 1, in which the machine-readable token is an RFID or NFC tag.

14. A temperature control system as claimed in claim 1, wherein the at least one mobile device comprises a plurality of mobile devices, wherein the controller is configured to receive user temperature preferences from each mobile device of the plurality of mobile devices, and wherein the controller applies a voting algorithm to determine a set temperature for a heating/cooling zone, with each received temperature preference is a vote used by the voting algorithm.

15. A temperature control system as claimed in claim 2, wherein the controller operating the means for controlling heating and/or cooling means to regulate the temperature in each heating/cooling zone is further based on the number of mobile devices present in the zone.

16. A temperature control system as claimed in claim 1, wherein the system stores personal temperature setting preferences of building occupants associated with the number of mobile devices present in a heating/cooling zone, and when a user arrives to the heating/cooling zone, the system recognises the presence of the user and automatically casts a vote on behalf of the user according to the stored personal temperature setting preference.

17. A temperature control system as claimed in claim 9, wherein the controller is adapted to create the heating/cooling profile by analysing historical data on heating/cooling zones using a machine learning algorithm to identify the time needed to reach a target temperature from a current temperature for each zone.

18. A temperature control system as claimed in claim 9, wherein the controller is adapted to monitor real-time occupancy of individual zones in the multi-occupancy building, wherein historical data is combined with real-time occupancy data to feed a machine learning algorithm to identify occupancy patterns to predict the occupancy of the heating/cooling zones, and wherein the controller is adapted to change the occupancy status of a room based on the occupancy prediction and trigger a change in temperature setting.

19. A temperature control system as claimed in claim 12, wherein the machine-readable optical label is a QR code.
